(19) United States
(12) Patent Application Publication
(10) Pub. No.: US 2019/0353240 A1
(43) Pub. Date: Nov. 21, 2019

(54) Multi-Speed Orbitless Drive

(71) Applicant: Orbitless Drives Inc., Vancouver (CA)

(72) Inventor: Leo J. Stocco, Vancouver (CA)

(73) Assignee: Orbitless Drives Inc., Vancouver, BC (CA)

(21) Appl. No.: 16/484,051

(22) PCT Filed: Feb. 20, 2018
(86) PCT No.: PCT/CA2018/050191

§ 371 Date: Aug. 6, 2019

Related U.S. Application Data
(60) Provisional application No. 62/462,350, filed on Feb. 22, 2017.

(30) Foreign Application Priority Data
Nov. 29, 2017 (CA) PCT/CA2017/051439

(51) Int. Cl. F16H 57/08; F16H 3/44

(52) U.S. Cl. CPC F16H 57/082; F16H 3/44

(57) ABSTRACT

A multi-speed orbitless drive is disclosed comprising a plurality of central engaging members and one or more carriers. Each engaging member and all carriers rotate at a different rate to simultaneously provide multiple reduction or over-drive ratios. A self-aligning central carrier may be included to minimize cost, complexity and footprint, to reduce friction, and to improve load sharing. A second offset carrier may be included to provide inertial balancing and to reduce internal forces for higher load capacity and power density. The present invention is well suited to applications that require in-line axes and high torque density such as constant mesh automotive transmissions.

### REFERENCE TO EARLIER FILED APPLICATIONS

This document is a continuation-in-part and claims priority to Patent Cooperation Treaty application number PCT/CA2015/050423 entitled “ORBITLESS GEARBOX” filed May 11, 2015 and assigned U.S. application Ser. No. 15/310,690 filed Nov. 11, 2016.

This document makes reference and claims priority to Patent Cooperation Treaty application number PCT/CA2015/050861 entitled “HYBRID ORBITLESS GEARBOX” filed Sep. 8, 2015.

This document makes reference and claims priority to Patent Cooperation Treaty application number PCT/CA2017/051439 entitled “COAXIAL ORBITLESS DRIVE” filed Nov. 29, 2017.

This application claims priority to U.S. provisional application number U.S. 62/462,350 entitled “NESTED ORBITLESS DRIVE” filed Feb. 22, 2017.

Each of the aforementioned patent applications are incorporated herein entirely by reference.

### TECHNICAL FIELD

The disclosure herein relates to a drive comprising a plurality of gears or other engaging members. More particularly, it relates to an apparatus providing two members that rotate at different rates.

### BACKGROUND

A conventional orbitless drive comprises a group of offset planet pinions which circulate a central sun on two or more carriers. The sun may be a pinion or a ring and may engage the planets either directly or through a stiff or flexible coupling.

The carriers rotate at a different rate than the sun, depending on the configuration and organization of the engaging members. The present invention combines multiple suns to provide a plurality of simultaneous transmission ratios.

The mechanical constraint provided by a ring sun avoids the requirement for a second carrier, although it may be included to actuate drive-shafts, provide inertial balancing or to reduce internal forces for increased load capacity.

The present invention may comprise stepped planets to modify the speed ratio or to provide additional speed ratios. It may be configured to provide a plurality of tightly and equally spaced reduction ratios in a small envelope with high efficiency.

### SUMMARY

Certain exemplary embodiments comprise a reference member (79), a first central member (41), a first offset carrier (19) and two or more offset members (39). The reference member (79) comprises a central axis (70) and a first offset axis (71) which are substantially parallel and spaced a first offset distance (91) apart. The first offset carrier (19) comprises a central axis (10) and a number of radial axes (11) equal to the number of offset members (39). All radial axes (11) are substantially parallel to, spaced a radial distance (93) apart from, and arranged circumferentially around the central axis (10). The central axis (10) and the first offset axis (71) are substantially co-axial and rotatably coupled (81). Each offset member (39) is a pinion engaging member comprising a first step (37), a central axis (30), and a first offset axis (31). The central axis (30) and first offset axis (31) of each offset member (39) are substantially parallel and spaced the first offset distance (91) apart. Each first offset axis (31) and a different radial axis (11) are substantially co-axial and rotatably coupled (82). The first central member (41) is a ring engaging member that simultaneously engages (61) all first steps (37). The first central member (41) and the central axis (70) are substantially co-axial and rotatably coupled (80).

In certain exemplary embodiments, each offset member (39) further comprises a second step (38).

Certain exemplary embodiments further comprise a central carrier (9). The central carrier (9) comprises a central axis (0) and a number of radial axes (1) equal to the number of offset members (39). All radial axes (1) are substantially parallel to, spaced the radial distance (93) apart from, and arranged circumferentially around the central axis (0). Each central axis (30) and a different radial axis (1) are substantially co-axial and rotatably coupled (83).

Certain exemplary embodiments further comprise a second offset carrier (29). The reference member (79) further comprises a second offset axis (72) which is substantially parallel to, and spaced a second offset distance (92) apart from the central axis (70). Each offset member (39) further comprises a second offset axis (32) which is substantially parallel to, and spaced the second offset distance (92) apart from the corresponding central axis (30). The second offset carrier (29) comprises a central axis (20) and a number of radial axes (21) equal to the number of offset members (39). All radial axes (21) are substantially parallel to, spaced the radial distance (93) apart from, and arranged circumferentially around the central axis (20). The central axis (20) and second offset axis (72) are substantially co-axial and rotatably coupled (84). Each second offset axis (32) and a different radial axis (21) are substantially co-axial and rotatably coupled (85).

Certain exemplary embodiments further comprise a second central member (42) which is a pinion engaging member that simultaneously engages (62) all first steps (37).

Certain exemplary embodiments further comprise a third central member (43) which is a ring engaging member that simultaneously engages (63) all second steps (38).

Certain exemplary embodiments further comprise a fourth central member (44) which is a pinion engaging member that simultaneously engages (64) all second steps (38).

### BRIEF DESCRIPTION OF DRAWINGS

FIG. 1 is a schematic side and front view in accordance with a first exemplary embodiment depicting the present invention.

FIG. 2 is a schematic side and front view in accordance with a second exemplary embodiment depicting the first exemplary embodiment further comprising stepped offset members (39).

FIG. 3 is a schematic side and front view in accordance with a third exemplary embodiment depicting the first exemplary embodiment further comprising a central carrier (9).

FIG. 4 is a schematic side and front view in accordance with a fourth exemplary embodiment depicting the first exemplary embodiment further comprising a second offset carrier (29).

FIG. 5 is a schematic side and front view in accordance with a fifth exemplary embodiment depicting the first exemplary embodiment further comprising a pinion second central member (42).

FIG. 6 is a schematic side and front view in accordance with a sixth exemplary embodiment depicting the second exemplary embodiment further comprising a ring third central member (43).

FIG. 7 is a schematic side and front view in accordance with a seventh exemplary embodiment depicting the second exemplary embodiment further comprising a pinion fourth central member (44).

FIG. 8 is a schematic side and front view in accordance with an eighth exemplary embodiment depicting the first exemplary embodiment further comprising all of the additional features depicted in the second through seventh exemplary embodiments.

FIG. 9 is a schematic side view in accordance with a ninth exemplary embodiment depicting an exemplary practical implementation of the present invention.

### REFERENCE NUMERALS

0—central axis
1—radial axis
9—central carrier
10—central axis
11—radial axis
19—first offset carrier
20—central axis
21—radial axis
29—second offset carrier
30—central axis
31—first offset axis
32—second offset axis
37—first step
38—second step
39—offset member
41—first central member
42—second central member
43—third central member
44—fourth central member
61—engagement
62—engagement
63—engagement
64—engagement
70—central axis
71—first offset axis
72—second offset axis
79—reference member
80—coupling
81—coupling
82—coupling
83—coupling
84—coupling
85—coupling
91—first offset distance
92—second offset distance
93—radial distance
100—ground
101—first input shaft
102—second input shaft
103—first output shaft
104—second output shaft

### Definitions

A gear, sprocket, pulley, friction or magnetic coupling, or any other type of member that engages and transmits power to a mate is defined as an engaging member.

An engaging member that engages on its exterior surface is defined as a pinion.

An engaging member that engages on its interior surface is defined as a ring.

The diameter of the effective rolling surface of a circular engaging member is defined as its pitch diameter.

A cable drive comprising two counter-acting, pre-loaded cables that are fixedly attached to two pulleys, is defined as a capstan cable coupling.

A chain, belt, cable, or any other means that changes shape while engaging two or more engaging members is defined as a flexible coupling.

A flexible coupling that simultaneously engages three or more engaging members is defined as a serpentine coupling.

Free-play between two engaged or coupled members is defined as backlash.

A rotating member with two or more parallel, non-coaxial axes is defined as a crankshaft.

An apparatus that transmits power between two rotating members is defined as a drive.

A drive that reduces velocity and amplifies torque is defined as a reduction drive.

A drive that amplifies velocity and reduces torque is defined as an over-drive.

A drive that may function as an over-drive is defined as back-drivable.

A drive that may not function as an over-drive is defined as self-locking.

A drive comprising a series or parallel combination of two or more drives is defined as multi-stage.

### DESCRIPTION OF EMBODIMENTS

Wherever possible, the same reference numerals are used throughout the accompanying drawings and descriptions to refer to the same or similar parts.

Components such as bearings, retainers and fasteners that do not substantially contribute to the understanding of the invention are neglected for the sake of simplicity.

When more than one reference member [79] is depicted, it is understood that they all correspond to a common integral reference member [79] with explicit connecting members omitted for the sake of simplicity.

When spur gears or schematic representations of spur gears are depicted in the accompanying drawings, it is understood that many other engaging means would suffice, such as conical, radial, offset, spiral, helical, double helical, or roller tooth gears, friction or magnetic couplings, chains and sprockets, or capstan cable couplings. It is also understood that associated gears may comprise any face width, tooth profile, pressure angle, or module and may be made from metal, plastic, or any other appropriate material.

Although three offset members (39) are often depicted in the accompanying drawings, it is understood that any number may be included, as long as they do not mechanically interfere.

Although single-stage drives are depicted in the accompanying drawings, it is understood that the present invention may be combined with any other type of drive to provide a multi-stage drive.

Although all offset members (39) are depicted in the accompanying drawings as being substantially equivalent, it is understood that neighboring offset members (39) may comprise gear teeth that are out of phase with the first and second offset axes (31,32) to improve assemble-ability.

Although all radial axes (1,11,21) are depicted in the accompanying drawings as being circumferentially equally spaced around the corresponding central axis (0,10,20), it is understood that they may be unequally spaced, although vibration may result.

It is understood that the male and female components of a rotatable coupling may often be interchanged.

It is understood that a back-drivable drive may provide either reduction or overdrive gearing by interchanging the roles of its high-speed and low-speed members. The roles of the reference, high-speed member and low-speed member may all be interchanged to obtain a desired reduction or overdrive ratio, or to cause members to rotate in the same or opposite directions. If any one member is used as an input member and the remaining two members are used as output members, a differential mechanism is obtained. Reduction, overdrive, differential, and reverse drives are all contemplated.

It is understood that the reference member (79), any central member (41,42,43,44), any offset member (39), or any carrier (9,19,29) may act as a reference, input or output member.

A representative sample of embodiments is included in the accompanying drawings for exemplary purposes only. A great number of additional kinematic arrangements are also contemplated. The scope of the present invention is not limited to the embodiments included but spans all possible combinations anticipated by the specification and claims.

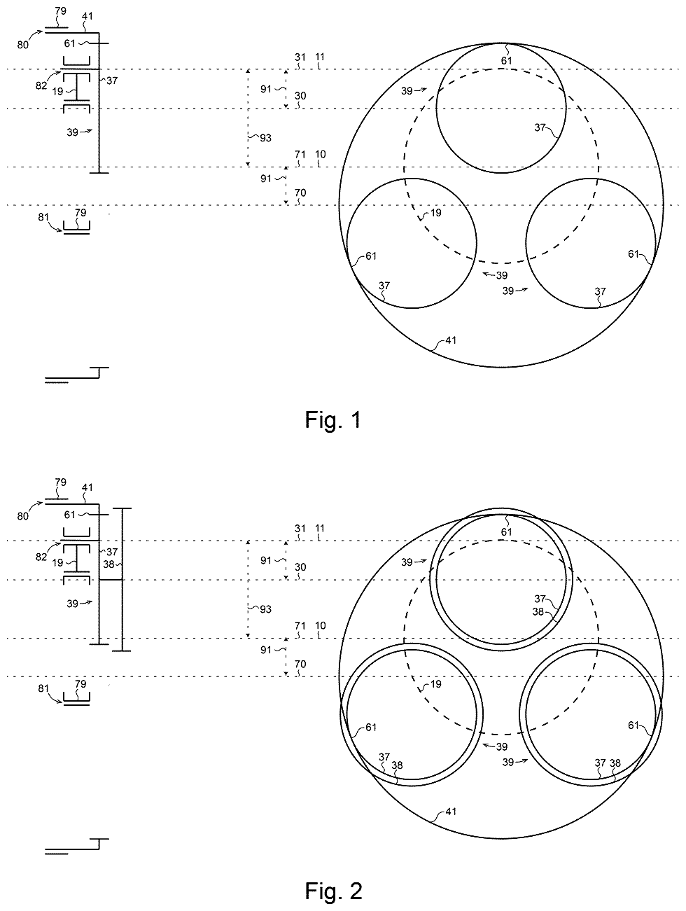

FIG. 1 illustrates a first exemplary embodiment of the present invention.

The first exemplary embodiment comprises a reference member (79), a first central member (41), a first offset carrier (19) and three offset members (39).

The reference member (79) comprises a central axis (70) and a first offset axis (71) which are substantially parallel and spaced a first offset distance (91) apart.

The first offset carrier (19) comprises a central axis (10) and three radial axes (11).

All radial axes (11) are substantially parallel to, spaced a radial distance (93) apart from, and arranged circumferentially around the central axis (10).

The central axis (10) and the first offset axis (71) are substantially co-axial and rotatably coupled (81).

Each offset member (39) is a pinion engaging member comprising a first step (37), a central axis (30) and a first offset axis (31).

The central axis (30) and first offset axis (31) are substantially parallel and spaced the first offset distance (91) apart.

Each first offset axis (31) and a different radial axis (11) are substantially co-axial and rotatably coupled (82).

The first central member (41) is a ring engaging member that simultaneously engages (61) the first step (37) of all offset members (39).

The first central member (41) and the central axis (70) are substantially co-axial and rotatably coupled (80).

FIG. 2 illustrates a second exemplary embodiment of the present invention which depicts first exemplary embodiment, and wherein each offset member (39) further comprises a second step (38).

The first step (37) and second step (38) of each offset member (39) each have a different pitch diameter.

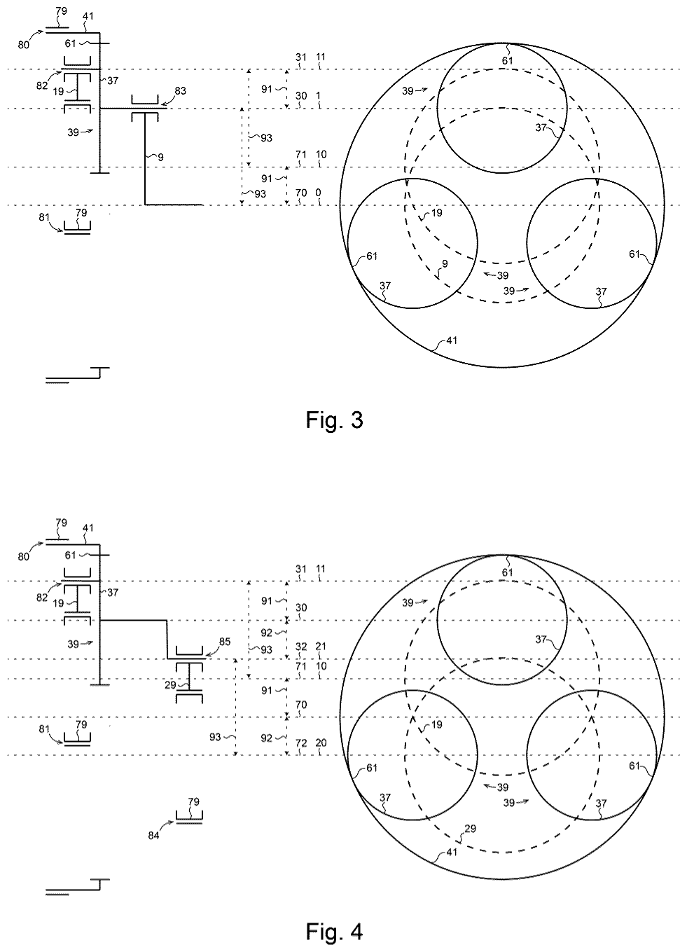

FIG. 3 illustrates a third exemplary embodiment of the present invention which depicts the first exemplary embodiment further comprising a central carrier (9).

The central carrier (9) comprises a central axis (0) and three radial axes (1).

All radial axes (1) are substantially parallel to, spaced a radial distance (93) apart from, and arranged circumferentially around the central axis (0).

Each central axis (30) and a different radial axis (1) are substantially co-axial and rotatably coupled (83).

FIG. 4 illustrates a fourth exemplary embodiment of the present invention which depicts the first exemplary embodiment further comprising a second offset carrier (29).

The reference member (79) further comprises a second offset axis (72) which is substantially parallel to, and spaced a second offset distance (92) apart from the central axis (70).

Each offset member (39) further comprises a second offset axis (32) which is substantially parallel to, and spaced the second offset distance (92) apart from the corresponding central axis (30).

The second offset carrier (29) comprises a central axis (20) and three radial axes (21).

All radial axes (21) are substantially parallel to, spaced the radial distance (93) apart from, and arranged circumferentially around the central axis (20).

The central axis (20) and the second offset axis (72) are substantially co-axial and rotatably coupled (84).

Each second offset axis (32) and a different radial axis (21) are substantially co-axial and rotatably coupled (85).

FIG. 5 illustrates a fifth exemplary embodiment of the present invention which depicts the first exemplary embodiment further comprising a second central member (42) which is a pinion engaging member that simultaneously engages (62) the first step (37) of all offset members (39).

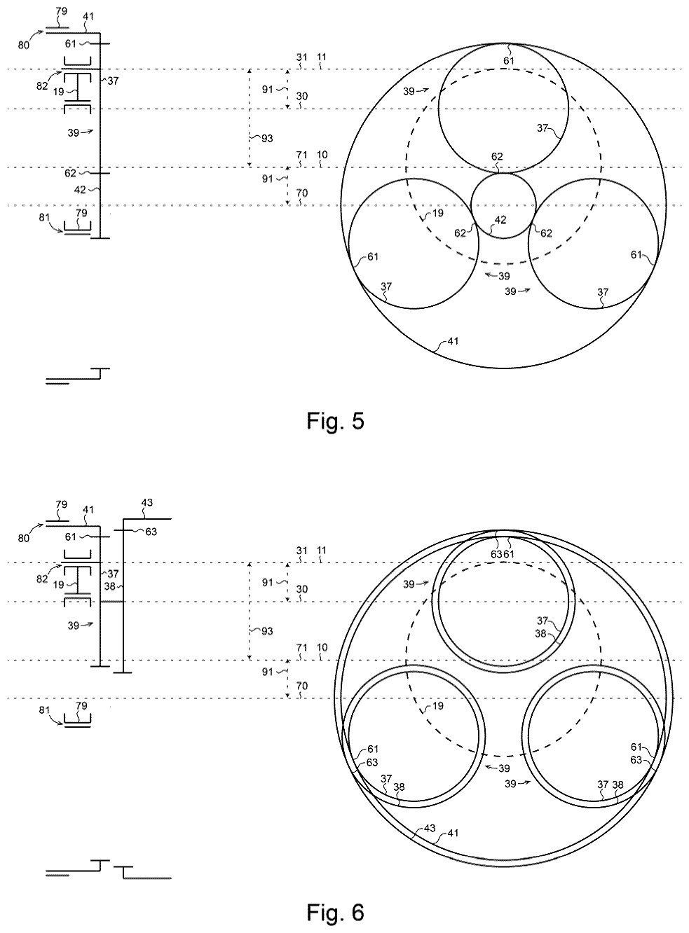

FIG. 6 illustrates a sixth exemplary embodiment of the present invention which depicts the second exemplary embodiment further comprising a third central member (43) which is a ring engaging member that simultaneously engages (63) the second step (38) of all offset members (39).

The first central member (41) and third central member (43) each have a different pitch diameter.

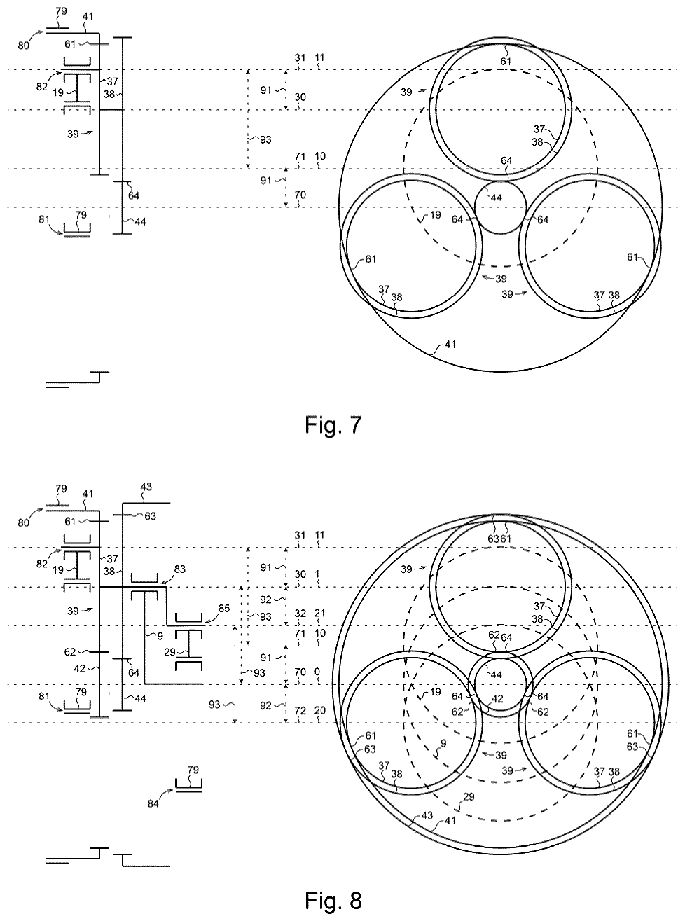

FIG. 7 illustrates a seventh exemplary embodiment of the present invention which depicts the second exemplary embodiment further comprising a fourth central member (44) which is a pinion engaging member that simultaneously engages (64) the second step (38) of all offset members (39).

FIG. 8 illustrates an eighth exemplary embodiment of the present invention which depicts the first exemplary embodiment further comprising all of the additional features depicted in the second, third, fourth, fifth, sixth and seventh exemplary embodiments.

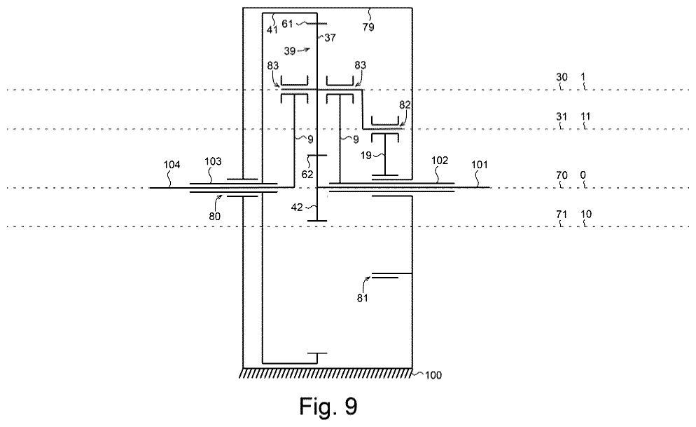

FIG. 9 illustrates a ninth exemplary embodiment of the present invention which depicts the first exemplary embodiment further comprising all of the additional features depicted in the third and fifth exemplary embodiments.

The ninth exemplary embodiment further comprises a static ground (100), a first high-speed drive-shaft (101), a second high-speed drive-shaft (102), a first low-speed drive-shaft (103), and a second low-speed drive-shaft (104).

The central carrier (9) comprises two sides which are integral and surround each offset member (39).

Each offset member (39) comprises a first step (37) that simultaneously engages the first central member (41) and second central member (42).

The reference member (79) is integral with ground (100).

The second central member (42) and the first high-speed drive-shaft (101) are co-axial and integral.

The central carrier (9) and the second high-speed drive-shaft (102) are co-axial and integral.

The first central member (42) and the first low-speed drive-shaft (103) are co-axial and integral.

The central carrier (9) and the second low-speed drive-shaft (104) are co-axial and integral.

### EXAMPLES

A first example considers the first and second exemplary embodiments illustrated in FIGS. 1 and 2.

Fixing the reference member (79) and rotating the first offset carrier (19) about its central axis (10) causes each offset member (39) to circulate around the central axis (70) without rotating about its own corresponding central axis (30).

The offset members (39) engage the first central member (41) and cause it to rotate at a lower rate than the offset carrier (19).

A second example considers the third and fourth exemplary embodiments illustrated in FIGS. 3 and 4.

Fixing the reference member (79) and rotating the first offset carrier (19) about its central axis (10) causes each offset member (39) to circulate around the central axis (70) without rotating about its own corresponding central axis (30).

All associated carriers (9, 19, 29) rotate in unison at a common rate and in a common direction about their respective central axes (0, 10, 20).

A third example considers the fifth exemplary embodiment illustrated in FIG. 5.

Fixing the reference member (79) and rotating the first offset carrier (19) about its central axis (10) causes each offset member (39) to circulate around the central axis (70) without rotating about its own corresponding central axis (30).

The offset members (39) engage the first central member (41) and cause it to rotate at a lower rate than the offset carrier (19).

The offset members (39) simultaneously engage the second central member (42) and cause it to rotate at a higher rate than the offset carrier (19).

A fourth example considers the sixth exemplary embodiment illustrated in FIG. 6.

Fixing the reference member (79) and rotating the first offset carrier (19) about its central axis (10) causes each offset member (39) to circulate around the central axis (70) without rotating about its own corresponding central axis (30).

The first step (37) of the offset members (39) engage the first central member (41) and cause it to rotate at a lower rate than the offset carrier (19).

The second step (38) of the offset members (39) engage the third central member (43) and cause it to rotate at a lower rate than the offset carrier (19) and a different rate than the first central member (41).

A fifth example considers the seventh exemplary embodiment illustrated in FIG. 7.

Fixing the reference member (79) and rotating the first offset carrier (19) about its central axis (10) causes each offset member (39) to circulate around the central axis (70) without rotating about its own corresponding central axis (30).

The first step (37) of the offset members (39) engage the first central member (41) and cause it to rotate at a lower rate than the offset carrier (19).

The second step (38) of the offset members (39) engage the fourth central member (44) and cause it to rotate at a higher rate than the offset carrier (19).

A sixth example considers the eighth exemplary embodiment illustrated in FIG. 8.

Fixing the reference member (79) and rotating the first offset carrier (19) about its central axis (10) causes each offset member (39) to circulate around the central axis (70) without rotating about its own corresponding central axis (30).

The first step (37) of the offset members (39) engage the first central member (41) and cause it to rotate at a lower rate than the offset carrier (19).

The first step (37) of the offset members (39) simultaneously engage the second central member (42) and cause it to rotate at a higher rate than the offset carrier (19).

The second step (38) of the offset members (39) engage the third central member (43) and cause it to rotate at a lower rate than the offset carrier (19) and a different rate than the first central member (41).

The second step (38) of the offset members (39) simultaneously engage the fourth central member (44) and cause it to rotate at a higher rate than the offset carrier (19) and a different rate than the second central member (42).

The central carrier (9), first offset carrier (19) and second offset carrier (29) all rotate at a common rate and in the same direction about their respective central axes (0,10,20).

A seventh example considers the ninth exemplary embodiment illustrated in FIG. 9.

When the second high-speed drive-shaft (102) is the input and the second low-speed drive-shaft (104) is the output, a first reduction ratio of 1:1 is provided.

When the second high-speed drive-shaft (102) is the input and the first low-speed drive-shaft (103) is the output, a second reduction ratio of r2:1 is provided where r2>1.

When the first high-speed drive-shaft (101) is the input and the second low-speed drive-shaft (104) is the output, a third reduction ratio of r3:1 is provided where r3>1 and r3≠2.

When the first high-speed drive-shaft (101) is the input and the first low-speed drive-shaft (103) is the output, a fourth reduction ratio of r4:1 is provided where r4>r2 and r4>r3.

For example, when the pitch diameters of the first central member (41), second central member (42) and offset members (39) are 10, 42 and 16 respectively, r1=1:1, r2=1.62, r3=2.6, and r4=4.2.

Since r4/r3≈r3/r2≈r2/r1≈1.6, equal ratio spacing is provided.

### ADVANTAGES

The exemplary embodiments disclosed herein have a number of advantageous properties.

Certain exemplary embodiments require only a single carrier, unlike a conventional orbitless drive which requires at least two.

Certain exemplary embodiments are more economical to produce than a conventional orbitless drive.

Certain exemplary embodiments provide a plurality of reduction ratios.

Certain exemplary embodiments provide a plurality of equally spaced reduction ratios.

Certain exemplary embodiments provide a plurality of reduction ratios that operate with high efficiency.

Other advantages are apparent from the disclosure herein.

1. An apparatus comprising a reference member (79), a first central member (41), a first offset carrier (19) and two or more offset members (39), wherein:
the reference member (79) comprises a central axis (70) and a first offset axis (71) which are substantially parallel and spaced a first offset distance (91) apart;
the first offset carrier (19) comprises a central axis (10) and a number of radial axes (11) equal to the number of offset members (39);
all radial axes (11) are substantially parallel to, spaced a radial distance (93) apart from, and arranged circumferentially around the central axis (10);
the central axis (10) and first offset axis (71) are substantially co-axial and rotatably coupled (81);
each offset member (39) is a pinion engaging member comprising a first step (37), a central axis (30), and a first offset axis (31);
the central axis (30) and first offset axis (31) of each offset member (39) are substantially parallel and spaced the first offset distance (91) apart;
each first offset axis (31) and a different radial axis (11) are substantially co-axial and rotatably coupled (82);
the first central member (41) is a ring engaging member that simultaneously engages (61) all first steps (37);
and the first central member (41) and the central axis (70) are substantially co-axial and rotatably coupled (80).

2. The apparatus of claim 1 wherein each offset member (39) further comprises a second step (38).

3. The apparatus of claim 1 further comprising a central carrier (9), and wherein:
the central carrier (9) comprises a central axis (0) and a number of radial axes (1) equal to the number of offset members (39);
all radial axes (1) are substantially parallel to, spaced the radial distance (93) apart from, and arranged circumferentially around the central axis (0);
and each central axis (30) and a different radial axis (1) are substantially co-axial and rotatably coupled (83).

4. The apparatus of claim 1 further comprising a second offset carrier (29), and wherein:
the reference member (79) further comprises a second offset axis (72) which is substantially parallel to, and spaced a second offset distance (92) apart from the central axis (70);
each offset member (39) further comprises a second offset axis (32) which is substantially parallel to, and spaced the second offset distance (92) apart from the corresponding central axis (30);
the second offset carrier (29) comprises a central axis (20) and a number of radial axes (21) equal to the number of offset members (39);
all radial axes (21) are substantially parallel to, spaced the radial distance (93) apart from, and arranged circumferentially around the central axis (20);
the central axis (20) and second offset axis (72) are substantially co-axial and rotatably coupled (84);
and each second offset axis (32) and a different radial axis (21) are substantially co-axial and rotatably coupled (85).

5. The apparatus of claim 1 further comprising a second central member (42) which is a pinion engaging member that simultaneously engages (62) all first steps (37).

6. The apparatus of claim 2 further comprising a third central member (43) which is a ring engaging member that simultaneously engages (63) all second steps (38).

7. The apparatus of claim 2 further comprising a fourth central member (44) which is a pinion engaging member that simultaneously engages (64) all second steps (38).

8. A method comprising:
providing a reference member (79), a first central ring engaging member (41), a first offset carrier (19) and two or more offset members (39);
providing the reference member (79) with a central axis (70) and a first offset axis (71) which are substantially parallel and spaced a first offset distance (91) apart;
providing the first offset carrier (19) with a central axis (10) and a number of radial axes (11) equal to the number of offset members (39);
locating all radial axes (11) such that they are substantially parallel to, spaced a radial distance (93) apart from, and arranged circumferentially around the central axis (10);
locating the central axis (10) and first offset axis (71) such that they are substantially co-axial and rotatably coupling (81) them;
providing each offset member (39) with a first pinion engaging step (37);
providing each offset member (39) with a central axis (30) and a first offset axis (31) which are substantially parallel and spaced the first offset distance (91) apart;
locating each first offset axis (31) and a different radial axis (11) such that they are substantially co-axial and rotatably coupling (82) them;
simultaneously engaging (61) the first central member (41) and all first steps (37);
and locating the first central member (41) and the central axis (70) such that they are substantially co-axial and rotatably coupling (80) them.

9. The method of claim 8 wherein each offset member (39) is further provided with a second pinion engaging step (38).

10. The method of claim 8 further providing a central carrier (9);
providing the central carrier (9) with a central axis (0) and a number of radial axes (1) equal to the number of offset members (39);
locating all radial axes (1) such that they are substantially parallel to, spaced the radial distance (93) apart from, and arranged circumferentially around the central axis (0);
and locating each central axis (30) and a different radial axis (1) such that they are substantially co-axial and rotatably coupling (83) them.

11. The method of claim 8 further providing a second offset carrier (29);
providing the reference member (79) with a second offset axis (72) which is substantially parallel to, and spaced a second offset distance (92) apart from the central axis (70);
providing each offset member (39) with a second offset axis (32) which is substantially parallel to, and spaced the second offset distance (92) apart from the corresponding central axis (30);
providing the second offset carrier (29) with a central axis (20) and a number of radial axes (21) equal to the number of offset members (39);
locating all radial axes (21) such that they are substantially parallel to, spaced the radial distance (93) apart from, and arranged circumferentially around the central axis (20);
locating the central axis (20) and the second offset axis (72) such that they are substantially co-axial and rotatably coupling (84) them;
and locating each second offset axis (32) and a different radial axis (21) such that they are substantially co-axial and rotatably coupling (85) them.

12. The method of claim 8 further providing a second central pinion engaging member (42) and simultaneously engaging (62) the second central member (42) and all first steps (37).

13. The method of claim 9 further providing a third central ring engaging member (43) and simultaneously engaging (63) the third central member (43) and all second steps (38).

14. The method of claim 9 further providing a fourth central pinion engaging member (44) and simultaneously engaging (64) the fourth central member (44) and all second steps (38).
